(19) United States
(12) Patent Application Publication
(10) Pub. No.: US 2010/0171804 A1
(43) Pub. Date: Jul. 8, 2010

(54) IMAGE RECORDING APPARATUS

(75) Inventors: Nobuaki Takahashi, Shizuoka-ken (JP); Atsushi Kubota, Shizuoka-ken (JP); Kazuhiko Ohtsu, Shizuoka-ken (JP); Satoshi Kaiho, Kanagawa-ken (JP); Takashi Kado, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/644,419

(22) Filed: Dec. 22, 2009

Related U.S. Application Data
(60) Provisional application No. 61/142,519, filed on Jan. 5, 2009.

(51) Int. Cl. B41J 2/01

(52) U.S. Cl. 347/104

(57) ABSTRACT

An image recording apparatus includes a conveyance unit which includes a conveyance belt and an air suction unit for sucking air through the conveyance belt to adsorb a recording medium onto the conveyance belt. A recording head ejects ink to carry out recording on the recording medium conveyed by the conveyance unit. An adsorption force adjusting unit adjusts the adsorption force for the recording medium on the conveyance belt, which occurs by sucking air, according to the size of the recording medium.

### CROSS-REFERENCE TO RELATED APPLICATION

This application is based upon and claims the benefit of priority from: U.S. Provisional Application No. 61/142,519 filed on Jan. 5, 2009, the entire contents of each of which are incorporated herein reference.

### TECHNICAL FIELD

The present invention relates to an image recording apparatus which ejects ink onto a recording medium conveyed on a conveyance path to perform recording.

### BACKGROUND

As an image recording apparatus, there is an ink jet head recording apparatus which is provided with ink jet heads. While conveying recording mediums, such as paper, using a conveyance unit, the ink jet head recording apparatus ejects ink from the ink jet heads, so that recording is carried out on the recording medium. The conveyance unit adsorbs the recording medium onto a conveyance belt and moves the conveyance belts to convey the recording medium. In the conveyance belt, a plurality of suction ports is provided. The recording medium is adsorbed onto the conveyance belt by a negative pressure which is generated by air sucked through the respective suction ports. For example, JP-A-2005-89074 discloses a technique in which the recording medium is adsorbed onto the conveyance belt by a negative pressure generated by air.

As for the recording medium adsorbed onto the conveyance belt, there are various sizes of recording mediums. When the recording mediums of different sizes are adsorbed onto the conveyance belt, the number of the respective suction ports covered with the recording medium differs according to the respective sizes. For this reason, the adsorption force differs for each of the sizes of the recording medium, so that the tip ends of the recording medium float from the conveyance belt for example. When the recording medium floats, the distance between the ejecting holes and the recording medium is not kept constant. The recording medium comes into contact with the discharge surface of the ink jet heads, so that the ink discharged from the ink jet heads is not landed on a predetermined position on the recording medium. Therefore, the image formed on the recording medium is unclear.

When both surfaces of the recording medium are recorded with an image, ink is landed on one surface of the recording medium so as to record an image, and then ink is landed on the other surface of the recording medium so as to record an image. When the ink is landed on one surface of the recording medium, the recording medium absorbs the ink and is swollen in a wave shape, that is, cockling is generated in some cases. For this reason, when the ink is landed on the other surface of the recording medium, the recording medium swollen in the wave shape comes into contact with the discharge surface of the ink jet heads as described above, so that the image formed on the recording medium is unclear.

### SUMMARY

An image recording apparatus according to an aspect of the present invention comprises a conveyance unit which includes a conveyance belt and an air suction unit for sucking air through the conveyance belt to adsorb a recording medium onto the conveyance belt; a recording head which ejects ink to carry out recording on the recording medium conveyed by the conveyance unit; and an adsorption force adjusting unit which adjusts adsorption force for the recording medium on the conveyance belt, which occurs by sucking air, according to the size of the recording medium.

### DESCRIPTION OF THE DRAWINGS

FIG. 1 is a diagram illustrating a configuration of an image recording apparatus according to a first embodiment of the invention.

FIG. 2 is a diagram illustrating a configuration of an image forming unit in the image recording apparatus.

FIG. 3 is an external view illustrating a conveyance belt of the image recording apparatus.

FIG. 4 is an external view illustrating a configuration of a conveyance housing of the image recording apparatus.

FIG. 5 is an external view illustrating a top plate of the image recording apparatus.

FIG. 6 is a diagram illustrating the bottom surface of an adsorption force adjusting unit of the image recording apparatus.

FIG. 7 is a perspective view illustrating a suction port covering plate of the image recording apparatus.

FIG. 8 is a diagram illustrating a side surface of a member moving unit of the image recording apparatus.

FIG. 9 is a diagram illustrating an open state of a suction port corresponding to a first size of recording medium of the image recording apparatus.

FIG. 10 is a diagram illustrating movement of a suction port covering plate by first and second cams of the image recording apparatus.

FIG. 11 is a diagram illustrating an open state of a suction port corresponding to a second size of recording medium of the image recording apparatus.

FIG. 12 is a diagram illustrating an open state of a suction port corresponding to a third size of recording medium of the image recording apparatus.

FIG. 13 is a diagram illustrating a configuration of a recording control unit of the image recording apparatus.

FIG. 14 is a diagram illustrating a configuration of a conveyance housing of the image recording apparatus according to a second embodiment of the invention.

FIG. 15 is a diagram illustrating a configuration of a recording control unit in the image recording apparatus.

FIG. 16 is a diagram illustrating a configuration of a conveyance housing of the image recording apparatus according to a third embodiment of the invention.

FIG. 17 is a diagram illustrating a layout of a duct of the image recording apparatus.

FIG. 18 is a diagram illustrating a configuration of a recording control unit of the image recording apparatus.

FIG. 19 is a diagram illustrating a configuration of the image recording apparatus according to a fourth embodiment of the invention.

FIG. 20 is a diagram illustrating a configuration of a recording control unit of the image recording apparatus.

### DETAILED DESCRIPTION

Hereinafter, a first embodiment of the invention will be described with reference to the drawings.

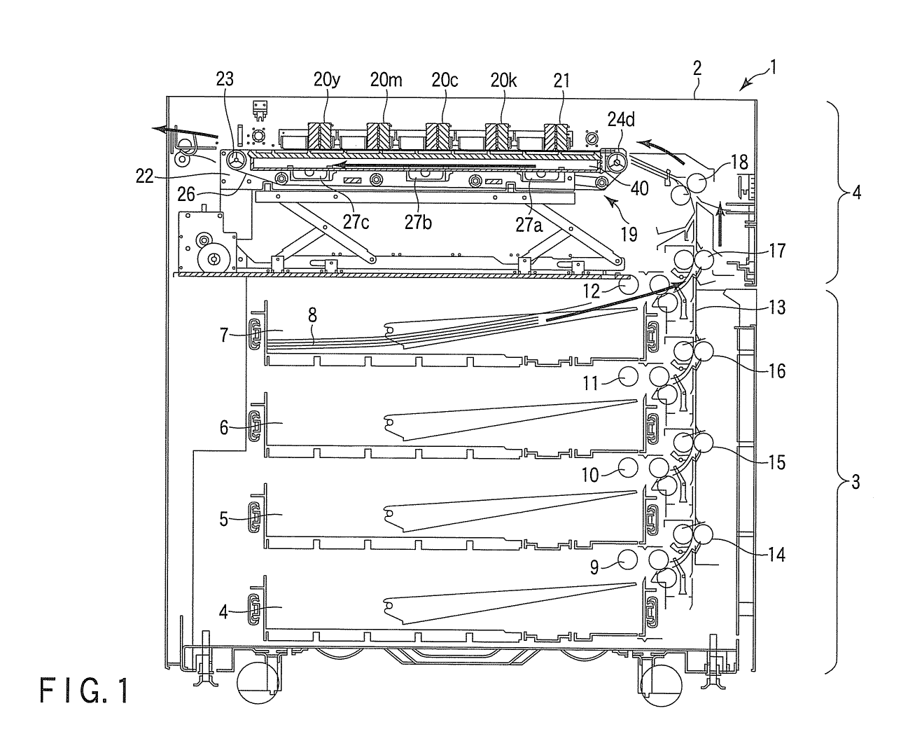

FIG. 1 is a cross-sectional view illustrating an image recording apparatus. The image recording apparatus 1 includes an apparatus housing 2. A medium feeding unit 3 is provided on the lower side in the apparatus housing 2. An image forming unit 4 is provided on the upper side in the apparatus housing 2. A plurality of paper feeding trays 4 to 7 are provided to be overlapped with each other in the vertical direction in the medium feeding unit 3. The respective paper feeding trays 4 to 7 are provided with recording mediums 8 which are different in size. The respective paper feeding trays 4 to 7 are provided with pickup rollers 9 to 12, respectively. The pickup rollers 9 to 12 pick up the recording medium 7 on the top position, among the plurality of the recording mediums 8 contained in the respective paper feeding trays 4 to 7, one by one so as to be fed to a medium sending mechanism 13.

The medium sending mechanism 13 is provided over the range from the medium feeding unit 3 to the image forming unit 4. The medium sending mechanism 13 includes respective pairs of sending rollers 14 to 18, and sends the recording medium 8 supplied from the paper feeding trays 4 to 7 to a conveyance mechanism 19 while rotating the respective pairs of the sending rollers 14 to 18.

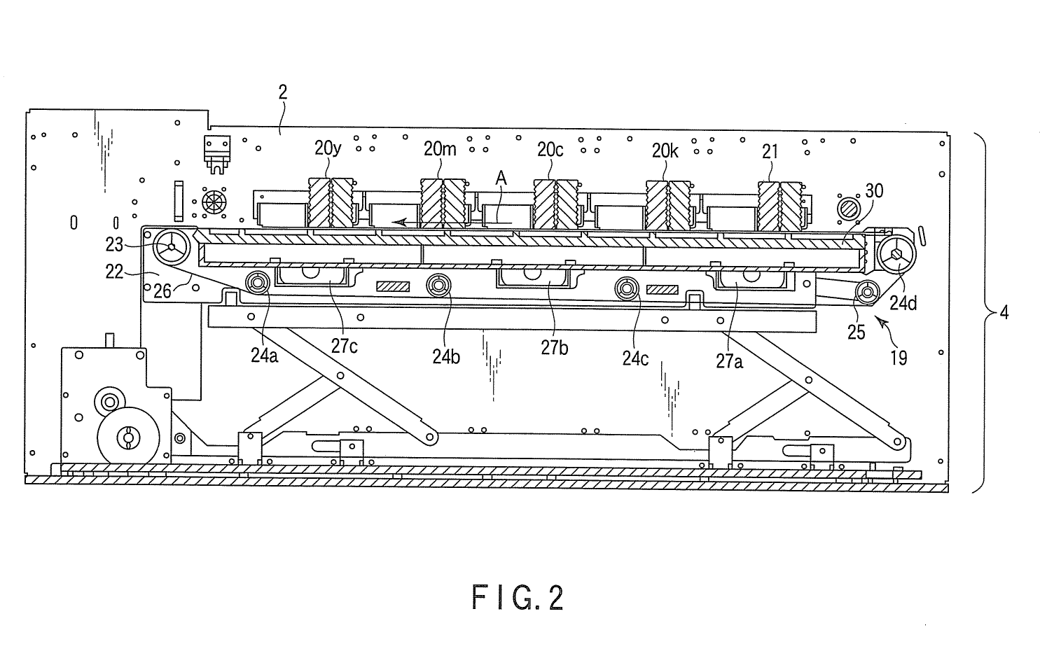

FIG. 2 is a diagram illustrating the configuration of the image forming unit 4. The image forming unit 4 records an image on the recording medium 8 which is supplied from the respective paper feeding trays 4 to 7. The image forming unit 4 includes the conveyance mechanism 19, four ink jet heads 20k, 20c, 20m, and 20y as recording heads, and a treatment liquid supply unit 21.

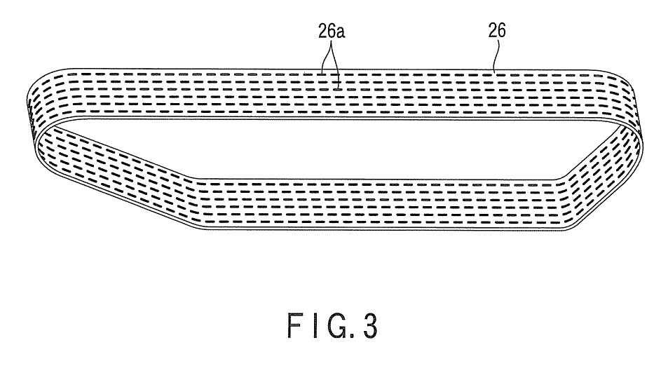

The conveyance mechanism 19 conveys the recording medium 8 supplied from the medium sending mechanism 13 under the respective ink jet heads 20k, 20c, 20m, and 20y in an arrow direction A with a constant speed. The conveyance mechanism 19 includes a conveyance housing 22. The conveyance housing 22 is provided with a driving roller 23 as a moving mechanism, a plurality of driven rollers 24a, 24b, 24c, and 24d, and a tension roller 25. Among the driving roller 23, the respective driven rollers 24a, 24b, 24c, and 24d, and the tension roller 25, a conveyance belt 26 is hung thereon. The conveyance belt 26 is formed in an endless stripe shape shown in FIG. 3. On the entire surface of the conveyance belt 26, a plurality of suction ports 26a is uniformly formed. The conveyance belt 26 is manufactured such that resin such as rubber is laminated on a fiber and the surface is polished. The conveyance belt 26 may be integrally formed with resin such as polyimide. The conveyance belt 26 may be formed such that both ends of a finite belt such as stainless steel are connected to be endlessly formed. The tension roller 25 urges the conveyance belt 26 with predetermined tension. The driving roller 23 rotates to move the conveyance belt 26 between the driving roller 23, the respective driven rollers 24a, 24b, 24c, and 24d, and the tension roller 25.

The respective ink jet heads 20k, 20c, 20m, and 20y are disposed at a predetermined interval therebetween in the conveyance direction A of the conveyance mechanism 19. The respective ink jet heads 20k, 20c, 20m, and 20y are provided with a plurality of ejecting holes for ejecting each color of ink, for example, black (K), cyan (C), magenta (M), and yellow (Y). The ink jet head 20k ejects, for example, K color of ink from the respective ejecting holes. The ink jet head 20c ejects, for example, C color of ink from the respective ejecting holes. The ink jet head 20m ejects, for example, M color of ink from the respective ejecting holes. The ink jet head 20y ejects, for example, Y color of ink from the respective ejecting holes. The number of the ink jet heads 20k, 20c, 20m, and 20y is not limited to 4, but at least only one of the ink jet heads may be disposed. For example, only the ink jet head 20k is disposed so as to record a monochrome image on the recording medium 2.

The treatment liquid supply unit 21 is provided on an upstream side of the respective ink jet heads 20k, 20c, 20m, and 20y in the conveyance direction A. The treatment liquid supply unit 21 applies the recording medium 8 with the treatment liquid. The treatment liquid serves to shorten time for fixing ink on the recording medium 8. For example, the treatment liquid includes a polymer liquid, such as carboxymethyl cellulose, polyvinyl alcohol, and polyvinyl acetate.

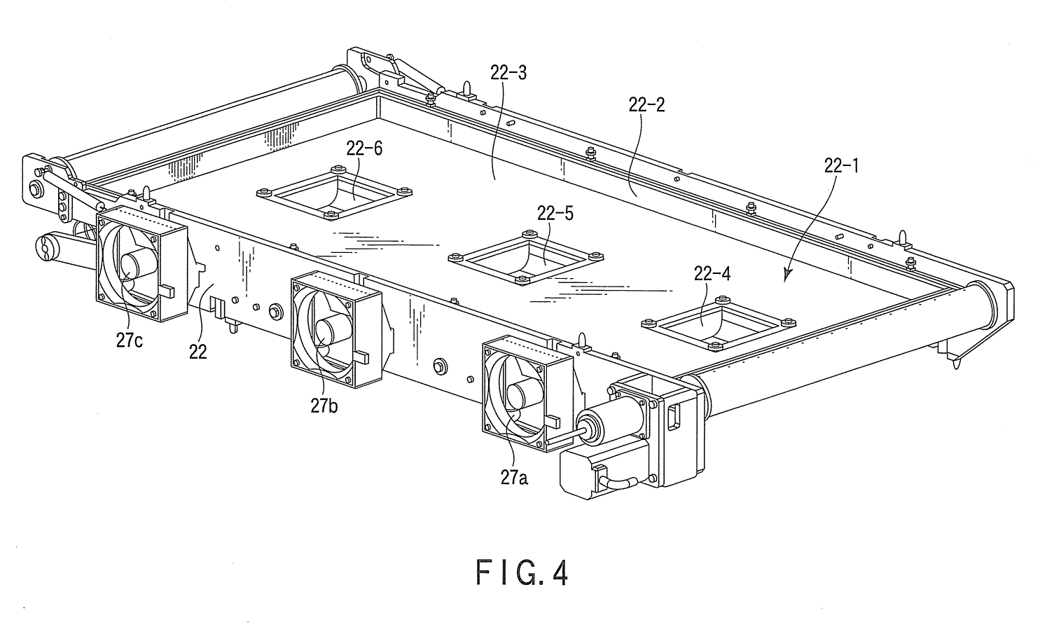

FIG. 4 is an external view illustrating the conveyance housing 22. On the side wall of the conveyance housing 22, for example, three adsorbing fans 27a, 27b, and 27c are provide as air suction units. In the conveyance housing 22, a suction frame 22-2 is provided to form a suction space 22-1 through which air flows. The bottom surface 22-3 of the suction space 22-1, for example, three duct openings 22-4 to 22-6 are provided. The respective duct openings 22-4 to 22-6 are formed to have the same opening area. The duct opening 22-4 is communicated with the adsorbing fan 27a. The duct opening 22-5 is communicated with the adsorbing fan 27b. The duct opening 22-6 is communicated with the adsorbing fan 27c. The respective adsorbing fans 27a, 27b, and 27c rotate to suck air through the respective duct openings 22-4 to 22-6.

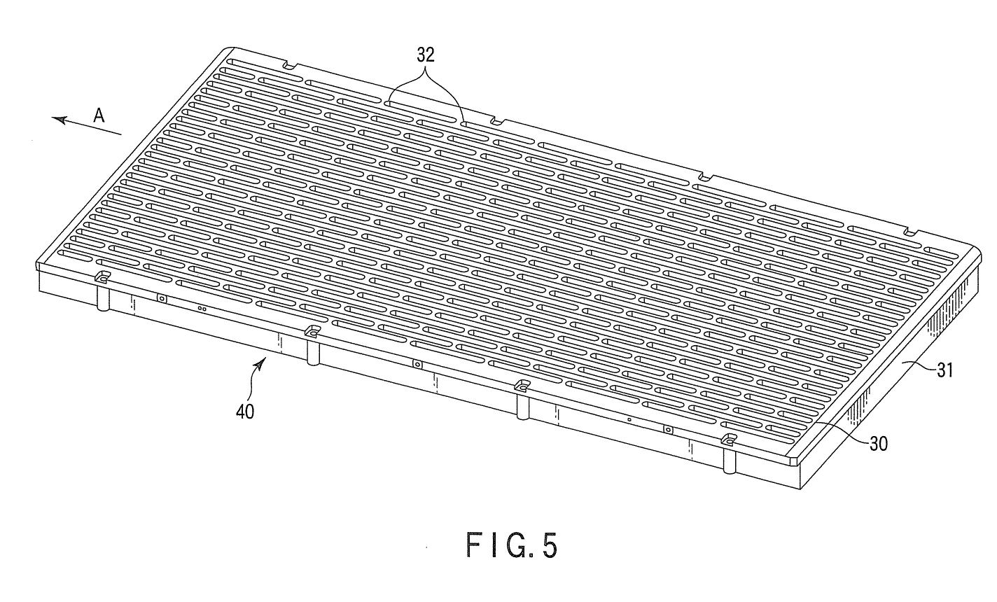

In the upper portion of the conveyance housing 22, a top plate 30 is provided as a belt support member shown in FIG. 5. The top plate 30 is provided on a top plate support frame 31. The top plate support frame 31 is formed in a rectangular shape along the peripheral of the top plate 30. Specifically, the top plate support frame 31 provided with the top plate 30 is provided on the upper portion of the conveyance housing 22 shown in FIG. 4, and closes the upper side of the suction space 22-1. The top plate 30 is formed in a flat shape. On the upper surface of the top plate 30, the conveyance belt 26 moves. The top plate 30 supports the conveyance belt 26 in a plane shape. The top plate 30 is provided with a plurality of first suction ports 32 at equal distances. Each of the first suction ports 32 is formed in a circular shape, for example.

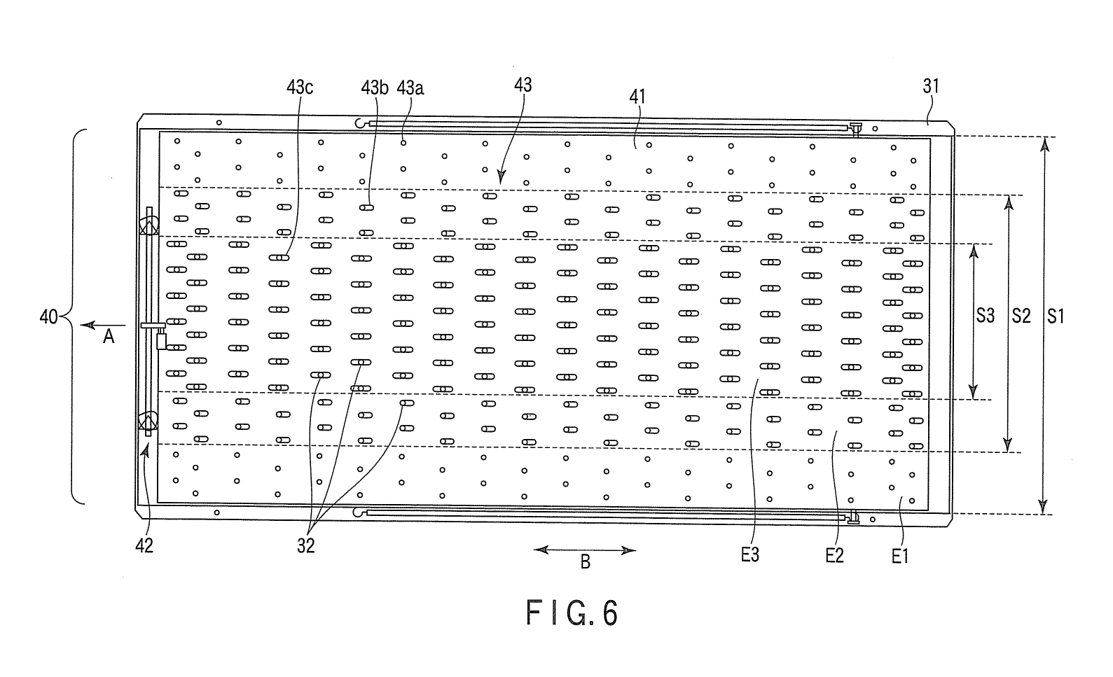

Under the top plate 30, an adsorption force adjusting unit 40 is provided. FIG. 6 is a diagram illustrating the configuration of the adsorption force adjusting unit 40 as viewed from the lower side of the top plate 30. The adsorption force adjusting unit 40 adjusts the adsorption force for the recording medium 8 on the conveyance belt 26, which occurs by sucking air of the respective adsorbing fans 27a, 27b, and 27c, according to the size of the recording medium 8. As the size of the recording medium 8 becomes smaller, the adsorption force adjusting unit 40 is configured to increase the adsorption force with respect to the recording medium 8 on the conveyance belt 26.

More specifically, the adsorption force adjusting unit 40 includes a suction port covering plate 41 as a suction port varying member, and a member moving unit 42 which moves the suction port covering plate 41 in a moving direction B. The moving direction B is parallel to the conveyance direction A.

The suction port covering plate 41 moves in the moving direction B to open the first suction ports 32 of the top plate 30. For example, the suction port covering plate 41 opens the first suction ports 32 in the top plate 30 in areas E1, E2, and E3 which correspond to the sizes S1, S2, and S3 of the recording medium 8. The respective sizes S1, S2, and S3 of the recording medium 8 indicates sizes in a width direction of the recording medium 8, that is, in a direction perpendicular to the conveyance direction. In the recording medium 8, the size S1 is the largest one, and the size becomes smaller from the size S2 to the size S3.

When the recording medium 8 is positioned on the center portion of the conveyance belt 26 regardless of the respective sizes S1, S2, and S3 so as to be conveyed, the first area E1 corresponds to the first size S1 of the recording medium 8. The first size S1 of the recording medium 8 is conveyed in the first area E1. The second area E2 corresponds to the second side S2 of the recording medium 8. The second size S2 of the recording medium 8 is conveyed in the second area E2. The third area E3 corresponds to the third size S3 of the recording medium 8. The third size S3 of the recording medium 8 is conveyed in the third area E3.

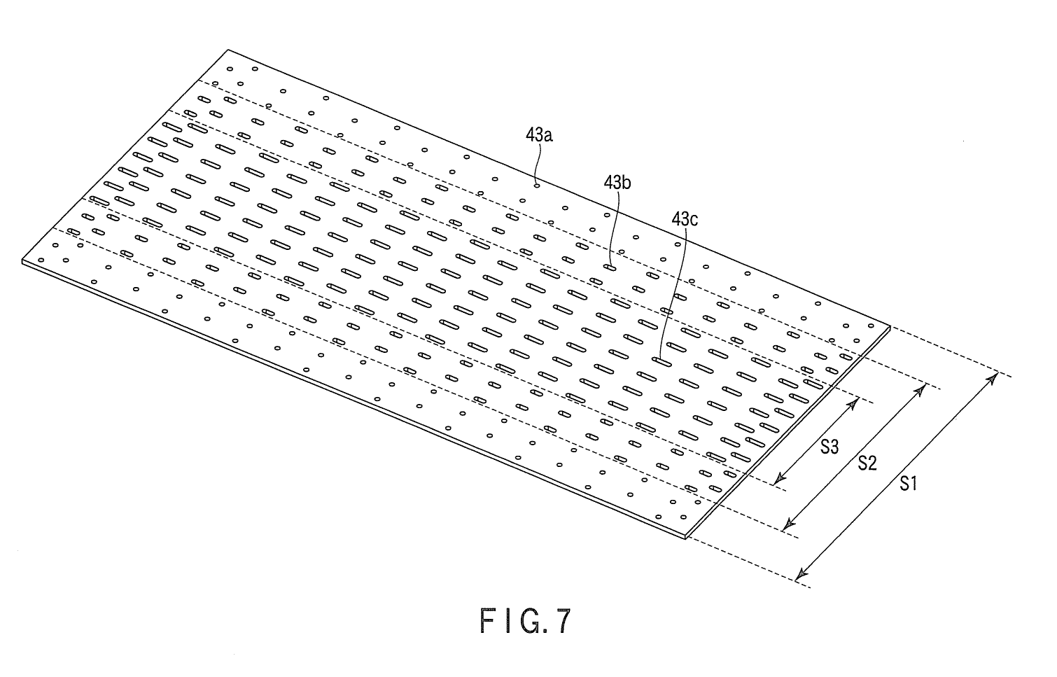

FIG. 7 is an external view of the suction port covering plate 41. The suction port covering plate 41 is formed in a flat shape. In the suction port covering plate 41, a plurality of second suction ports 43 are provided at equal intervals. The respective intervals of the second suction ports 43 is the same as those of the first suction ports 32 of the top plate 30. The sizes of the respective second suction ports 43 are different for the respective areas E1, E2, and E3.

The respective second suction ports 43 of the suction port covering plate 41 includes a plurality of second suction ports 43a, a plurality of second suction ports 43b, and a plurality of second suction ports 43c. The sizes of the respective second suction ports 43 becomes larger in the order of the respective second suction ports 43a, the respective second suction ports 43b, and the respective second suction ports 43c. The respective second suction ports 43a are formed, for example, in a circular shape. The respective second suction ports 43b are formed in a rectangular shape in which the conveyance direction of the recording medium 8 is a longitudinal direction. The longitudinal direction of the respective second suction ports 43b is provided to be the same direction as the moving direction B of the suction port covering plate 41. The respective second suction ports 43c are formed in long rectangular shape. The longitudinal direction of the respective second suction ports 43c is provided to be the same direction as the moving direction B of the suction port covering plate 41. The length of the respective second suction ports 43c in the longitudinal direction is provided to be longer than the length of the respective second suction ports 43b in the longitudinal direction. The length of the respective second suction ports 43c in the longitudinal direction is provided to be substantially equal to the moving range of the suction port covering plate 41 in the moving direction B. That is, as the second suction port 43 is close to the center with respect to the same direction as the conveyance direction of the recording medium 8, the length of the respective second suction ports 43c in the longitudinal direction becomes longer.

In the first area E1, the respective second suction ports 43a, the respective second suction ports 43b, and the respective second suction ports 43c are provided. In the third area E3, the respective second suction ports 43c are provided. In an area excepting the third area E3 in the second area E2, the respective second suction ports 43b are provided. In an area excepting the second area E2 in the third area E3, the respective second suction ports 43a are provided.

The member moving unit 42 moves the suction port covering plate 41 in the moving direction B with respect to the top plate 30, and varies the respective first suction ports 43 (43a, 43b, and 43c) in the open state according to the sizes S1, S2, and S3 of the recording medium 8. When the size of the recording medium 8 is the size S1, the member moving unit 42 opens all of the respective first suction ports 43 (43a, 43b, and 43c) in the top plate 30. When the size of the recording medium 8 is the size S2, the member moving unit 42 opens the respective first suction ports 43b and 43c in the top plate 30. When the size of the recording medium 8 is the size S3, the member moving unit 42 opens the respective first suction ports 43c in the top plate 30.

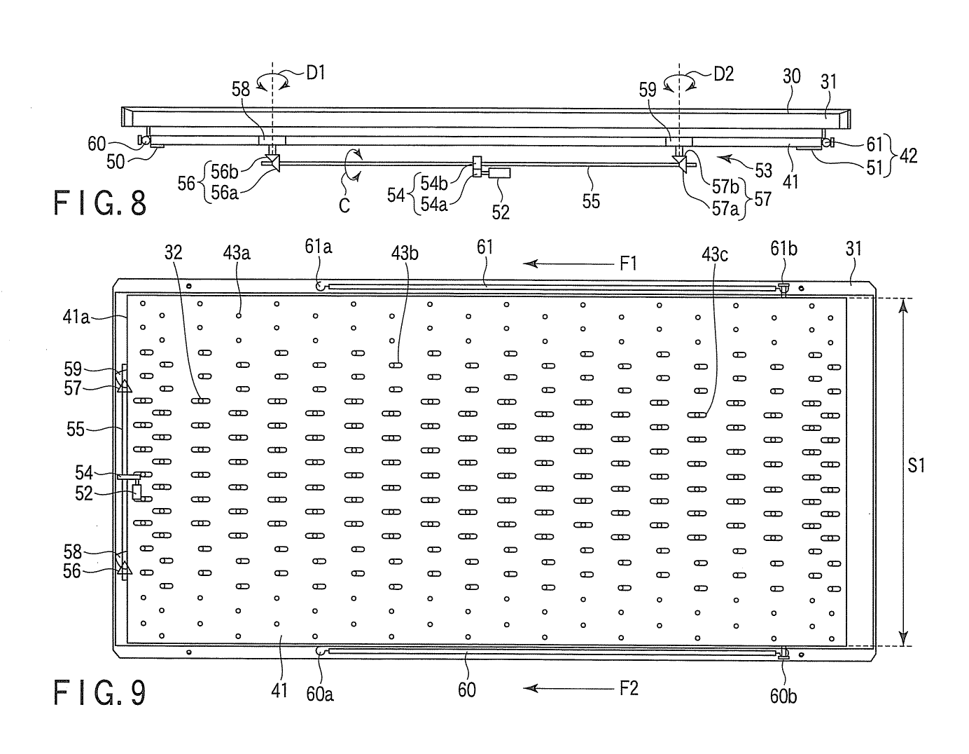

FIG. 8 is a diagram illustrating the configuration of the side surface of the member moving unit 42. FIG. 9 is a diagram illustrating the configuration of the bottom surface side of the member moving unit 42. In the lower portion of the top plate 30, the respective sliders 50 and 51 are provided. The respective sliders 50 and 51 are formed in the L shape in sectional view. The respective sliders 50 and 51 movably support the suction port covering plate 41 in the moving direction B.

In the member moving unit 42, a cover driving motor 52 is provided as a drive source. On the rotation shaft of the cover driving motor 52, a delivery mechanism 53 is connected. The delivery mechanism 53 converts the rotation of the rotation shaft of the cover driving motor 52 into a linear movement in the moving direction B, and delivers the linear movement to the suction port covering plate 41.

Specifically, the rotation shaft of the cover driving motor 52 is provided with a first gear unit 54. The first gear unit 54 delivers the rotation of the rotation shaft of the cover driving motor 52 to a connection member 55. The first gear unit 54 is constituted by two gears 54a and 54b. The respective gears 54a and 54b are formed in spur gears, and are meshed with each other. The gear 54a is provided at the rotation shaft of the cover driving motor 52. The gear 54b is provided at the center portion of the connection member 55.

The connection member 55 is formed in a cylindrical shape. The connection member 55 receives torque of the cover driving motor 52 via the delivery mechanism 53 so as to rotate in the arrow direction C. The connection member 55 in the arrow direction C rotates around the rotation shaft of the connection member 55 in the longitudinal direction.

On both ends of the connection member 55, a second gear unit 56 and a third gear unit 57 are provided, respectively. Each of the gear units 56 and 57 converts an axial direction of the rotation of the connection member 55 in the arrow direction C into the rotation shaft in the arrow directions D1 and D2 by 90°. The second gear unit 56 is constituted by two gears 56a and 56b. The respective gears 56a and 56b are formed as conical gears, and meshed with each other. The gear 56a is provided at the connection member 55. The gear 56b is provided at a first cam 58. The third gear unit 57 is constituted by two gears 57a and 57b. The respective gears 57a and 57b is formed as conical gears, and meshed with each other. The gear 57a is provided at the connection member 55. The gear 57b is provided at a second cam 59. The first cam 58 and the second cam 59 come into contact with one end of the suction port covering plate 41.

In both lower ends of the top plate support frame 31, two springs 60 and 61 are provided respectively. Both ends 60a and 61a of the respective springs 60 and 61 are held on to the lower portion of the top plate support frame 31, respectively. Both the other ends 60b and 61b of the respective springs 60 and 61 are held on to the suction port covering plate 41, respectively. The respective springs 60 and 61 are urged in the arrow directions F1 and F2 equal to the direction of the conveyance direction A, respectively. Therefore, the suction port covering plate 41 comes into pressing contact with the first and second cams 58 and 59 by the constant urging force of the respective springs 60 and 61.

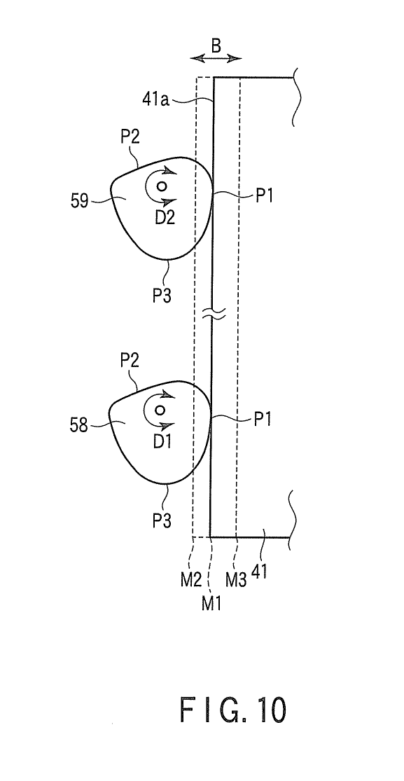

FIG. 10 shows the movement of the suction port covering plate 41 by the first and second cams 58 and 59. The same cam surfaces of the first and second cams 58 and 59 face the suction port covering plate 41, and rotate in the arrow directions D1 and D2. For example, the first and second cams 58 and 59 stop rotating in a state of coming into contact with the suction port covering plate 41 at one point among three points P1, P2, and 93. When the cam stops rotating at a first contact point P1, the end of the suction port covering plate 41 moves to the a stop position M1. When the cam stops rotating at a second contact point P2, the end of the suction port covering plate 41 moves to a stop position M2. When the cam stops rotating at a third contact point P3, the end of the suction port covering plate 41 moves to a stop position M3.

FIG. 9 shows a state where the first and second cams 58 and 59 come into contact with the suction port covering plate 41 at the respective first contact points P1. In this state, the respective first suction ports 32 of the top plate 30 in the first area E1 and all the second suction ports 43a, 43b, and 43c of the suction port covering plate 41 are overlapped with each other. Therefore, all the first suction ports 32 in the first area E1 of the top plate 30 are in the open state.

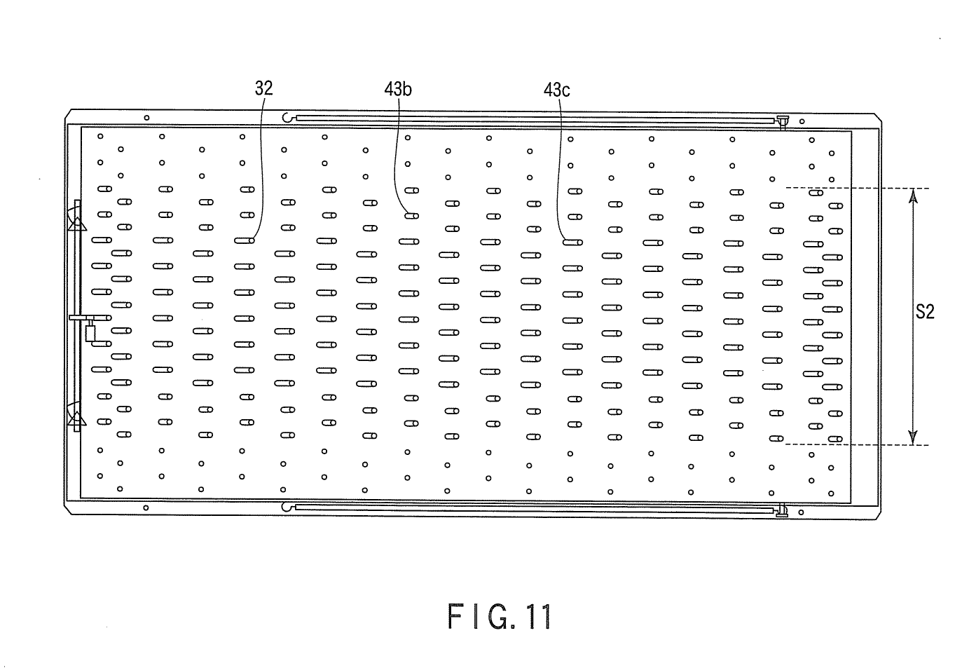

FIG. 11 shows a state where the first and second cams 58 and 59 come into contact with the suction port covering plate 41 at the respective second contact points 92. In this state, the respective first suction ports 32 of the top plate 30 in the second area E2 are overlapped with the respective second suction ports 43b and 43c among the suction port covering plate 41. Therefore, the respective first suction ports 32 of the top plate 30 in the second area E2 are in the open state. The respective first suction ports 32 outside the second area E2 of the top plate 30 are closed by the suction port covering plate 41.

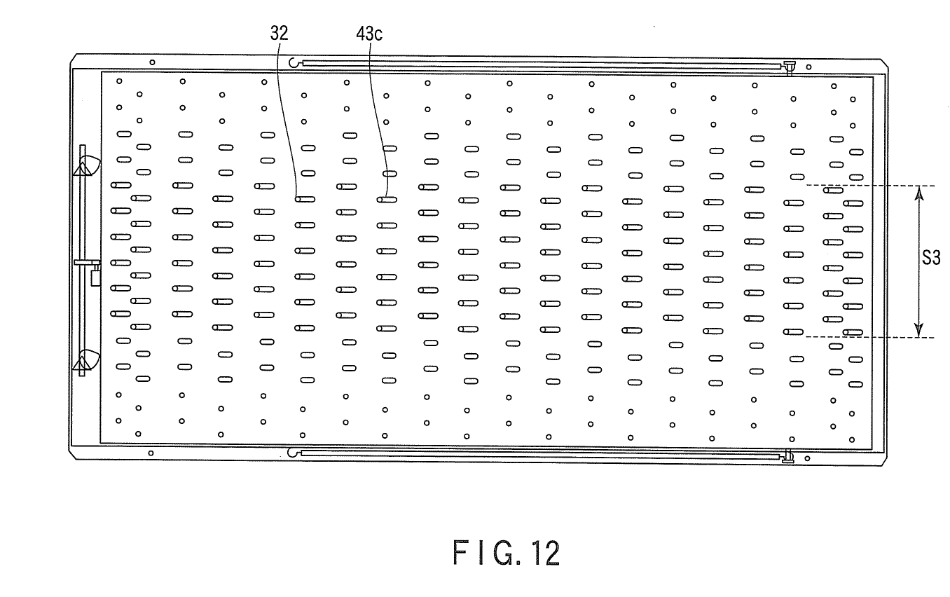

FIG. 12 shows a state where the first and second cams 58 and 59 come into contact with the suction port covering plate 41 at the second contact point 93. In this state, the respective first suction ports 32 of the top plate 30 in the first area E1 are overlapped with the respective second suction ports 43c among the suction port covering plate 41. Therefore, the respective first suction ports 32 of the top plate 30 in the third area E3 are in the open state. The respective first suction ports 32 outside the third area E3 of the top plate 30 are closed by the suction port covering plate 41.

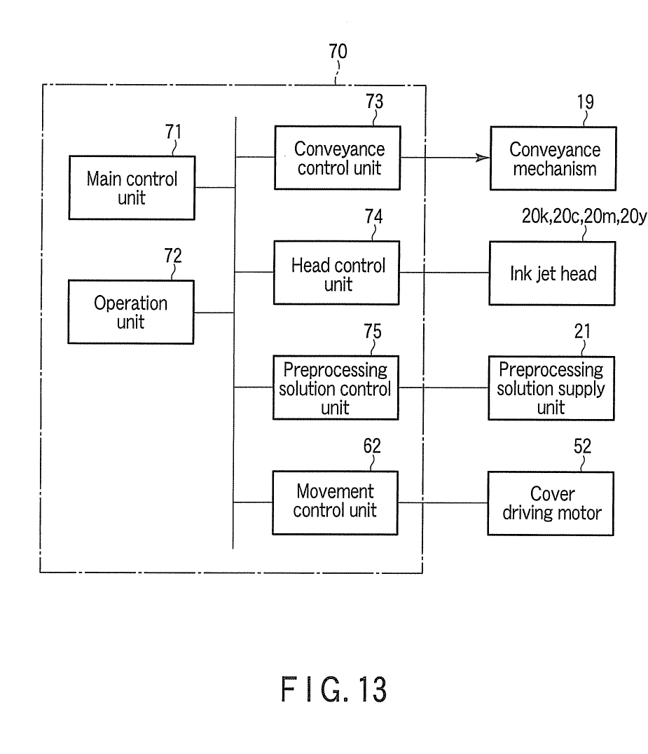

FIG. 13 is a diagram illustrating the configuration of a recording control unit 70. The recording control unit 70 controls each operation of the conveyance mechanism 19, the respective ink jet heads 20k, 20c, 20m, and 20y, and the member moving unit 42, and the likes, and carries out recording of the image on the recording medium 8. The recording control unit 70 includes a main control unit 71 constituted by the CPU and the likes. The main control unit 71 is connected to an operation unit 72, a conveyance control unit 73, a head control unit 74, a treatment liquid control unit 75, and a movement control unit 62.

The operation unit 72 is constituted by various kinds of keys, a keyboard, and the likes. For example, the operation unit 72 receives a manual operation of a user, so that the sizes S1, S2, and S3 of the recording medium 8 can be set.

The conveyance control unit 73 rotatably drives the driving roller 23 of the conveyance mechanism 19 so as to move the conveyance belt 26 between the driving roller 23, the respective driven rollers 24a, 24b, 24c, and 24d, and the tension roller 25. When the recording medium 8 reaches the conveyance mechanism 19, the conveyance control unit 73 prompts the respective adsorbing fans 27a, 27b, and 27c to rotate. Then, air is sucked through the respective suction ports 26a of the conveyance belt 26. Therefore, the recording medium 8 is adsorbed on the conveyance belt 26.

The head control unit 74 controls the respective ink jet heads 20k, 20c, 20m, and 20y to eject ink according to the recording data.

The treatment liquid control unit 75 controls the operation of the treatment liquid supply unit 21 so as to apply the recording medium 8 with the treatment liquid.

The movement control unit 62 controls the cover driving motor 52 to be driven so as to control a travel amount of the suction port covering plate 41 in the arrow direction B according to the sizes S1, S2, and S3 of the recording medium 8.

Specifically, the movement control unit 62 receives the sizes S1, S2, and S3 of the recording medium 8 which is set by the operation unit 72. When the size of the recording medium 8 is the size S1, the movement control unit 62 controls the cover driving motor 52 to be driven such that the first and second cams 58 and 59 come into contact with the suction port covering plate 41 at the first contact point P1 as shown in FIG. 9. Therefore, all of the first suction ports 32 of the top plate 30 in the first area E1 are in the open state as shown in FIG. 9.

When the size of the recording medium 8 is the size S2, the movement control unit 62 controls the cover driving motor 52 to be driven such that the first and second cams 58 and 59 come into contact with the suction port covering plate 41 at the second contact point P2. Therefore, the respective first suction ports 32 of the top plate 30 in the second area E2 are in the open state as shown in FIG. 11.

When the size of the recording medium 8 is the size S3, the movement control unit 62 controls the cover driving motor 52 to be driven such that the first and second cams 58 and 59 come into contact with the suction port covering plate 41 at the third contact point P3. Therefore, the respective first suction ports 32 of the top plate 30 in the third area E3 are in the open state as shown in FIG. 12.

Next, the operation of the apparatus as configured above will be described.

When a user manually operates the operation unit 72 to set the size S1 of the recording medium 8, the movement control unit 62 controls the cover driving motor 52 to be driven, so that the first and second cams 58 and 59 come into contact with the suction port covering plate 41 at the respective first contact points P1 as shown in FIG. 9. That is, the rotation of the cover driving motor 52 is transmitted to the connection member 55 via the first gear unit 54 as shown in FIG. 8 so as to rotate the connection member 55. The rotation of the connection member 55 is transmitted to the first and second cams 58 and 59 via both ends of the second and third gear units 56 and 57. The first and second cams 58 and 59 rotate in the arrow directions D1 and D2 as shown in FIG. 9, respectively. Therefore, the first and second cams 58 and 59 come into contact with the suction port covering plate 41 at the respective first contact points P1, respectively.

The suction port covering plate 41 comes into pressing contact with the first and second cams 58 and 59 by the urging force of the springs 60 and 61, and therefore moves in the arrow direction B according to the cam surface positions of the first and second cams 58 and 59. When the first and second cams 58 and 59 stop at the first contact point P1, the end of the suction port covering plate 41 moves to the stop position M1 as shown in FIG. 10. As a result, the respective first suction ports 32 of the top plate 30 and all of the second suction ports 43a, 43b, and 43c in the first area E1 in the suction port covering plate 41 are overlapped with each other as shown in FIG. 9. Therefore, all of the first suction ports 32 of the top plate 30 in the first area E1 are in the open state.

Further, the size S1 of the recording medium 8 is picked up by the pickup roller 9 from, for example, the paper feeding tray 4 and supplied to the medium sending mechanism 13. The medium sending mechanism 13 sends the recording medium 8 supplied from the paper feeding tray 4 to the conveyance mechanism 19.

The conveyance control unit 73 rotatably drives the driving roller 23 of the conveyance mechanism 19 so as to move the conveyance belt 26 between the driving roller 23, the respective driven rollers 24a, 24b, 24c, and 24d, and the tension roller 25. The conveyance control unit 73 rotates the respective adsorbing fans 27a, 27b, and 27c. As the respective adsorbing fans 27a, 27b, and 27c rotate, air is sucked through the respective suction ports 26a of the conveyance belt 26, the respective first suction ports 32 of the top plate 30, and the respective second suction ports 43 of the suction port covering plate 41. As the air is sucked, the size S1 of the recording medium 8 is adsorbed onto the conveyance belt 26.

The treatment liquid control unit 75 controls the operation of the treatment liquid supply unit 21 so as to apply the recording medium 8 with the treatment liquid.

The head control unit 74 controls the respective ink jet heads 20k, 20c, 20m, and 20y to eject ink according to the recording data. The respective ink jet heads 20k, 20c, 20m, and 20y eject ink onto the recording medium 8 conveyed on the conveyance belt 26 so as to record an image.

When the size of the recording medium 8 is set to the size S2 in the operation unit 72, the movement control unit 62 contacts the first and second cams 58 and 59 with the suction port covering plate 41 at the respective second contact points P2 as shown in FIG. 9. Since the suction port covering plate 41 moves to the stop position M2, the respective first suction ports 32 of the top plate 30 and the respective second suction ports 43b and 43c in the second area E2 of the suction port covering plate 41 are overlapped with each other as shown in FIG. 11. Therefore, the respective first suction ports 32 in the second area E2 are in the open state. Air is sucked through the respective first suction ports 32 in the second area E2. As the air is sucked, the size S2 of the recording medium 8 is adsorbed onto the conveyance belt 26.

When the size of the recording medium 8 is set to the size S3 in the operation unit 72, the movement control unit 62 controls the cover driving motor 52 to be driven, so that the first and second cams 58 and 59 come into contact with the suction port covering plate 41 at the respective third contact points P3 as shown in FIG. 9. Since the suction port covering plate 41 moves to the stop position M3, the respective first suction ports 32 of the top plate 30 and the respective second suction ports 43c in the third area E3 of the suction port covering plate 41 are overlapped with each other as shown in FIG. 12. Therefore, the respective first suction ports 32 in the third area E3 are in the open state. Air is sucked through the respective first suction ports 32 in the third area E3. As the air is sucked, the size S3 of the recording medium 8 is adsorbed onto the conveyance belt 26.

As described above, according to the first embodiment, the suction port covering plate 41 moves according to the respective sizes S1, S2, and S3 of the recording medium 8, and the respective first suction ports 32 in the top plate 30 to be in the open state are varied according to the first, second, and third areas E1, E2, and E3. Therefore, the respective sizes S1, S2, and S3 of the recording medium 8 are matched with the sizes of the first, second, and third areas E1, E2, and E3 through which air is sucked. The recording medium 8 is adsorbed onto the conveyance belt 26 with a sucking force according to the respective sizes S1, S2, and S3.

The sucking force by the respective adsorbing fans 27a, 27b, and 27c is constant per unit area, and therefore the adsorption force for the recording medium 8 on the conveyance belt 26 becomes larger in the order narrowing the areas, that is, the third, second, and first area E3, E2, and E1.

The recording medium 8 becomes light in weight per unit area in the order of the sizes S1, S2, and S3. When the recording medium 8 is light in weight, the recording medium 8 easily floats above the conveyance belt 26, so that there is a need to adsorb the recording medium 8 on the conveyance belt 26 with a large sucking force. When the recording medium 8 is heavy in weight, the recording medium 8 hardly floats above the conveyance belt 26, so that the recording medium 8 is held on to the conveyance belt 26 with a small sucking force.

Therefore, since the recording medium 8 can be adsorbed on the conveyance belt 26 with adsorption force according to the sizes S1, S2, and S3 of the recording medium 8, a high recording quality can be achieved on the recording medium 8.

Next, the second embodiment of the invention will be described with reference to the drawings.

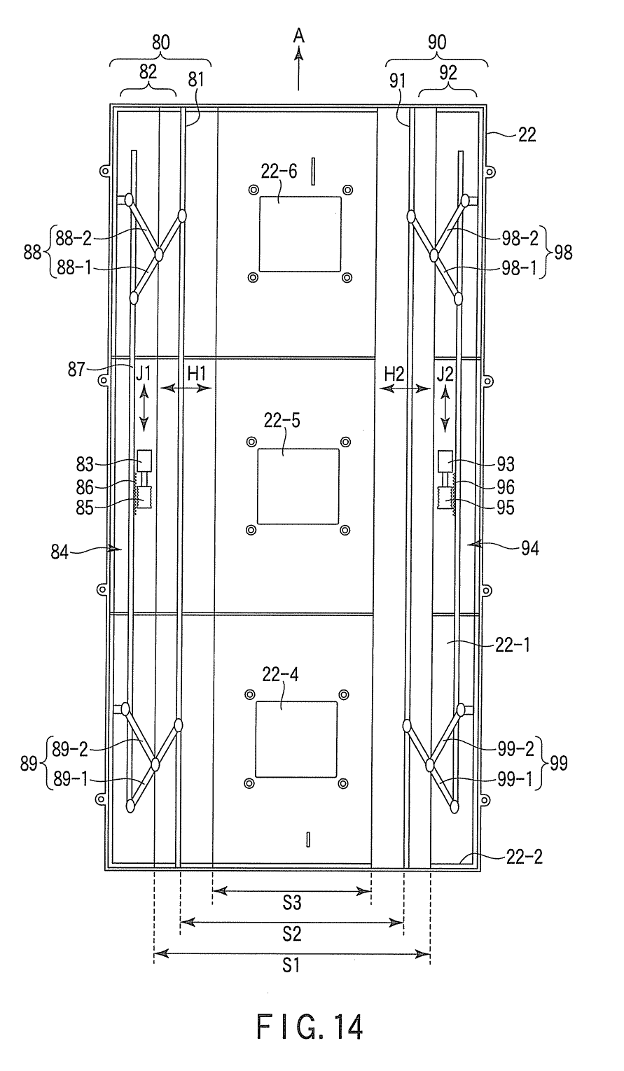

FIG. 14 is a diagram illustrating the configuration of the conveyance housing 22 of the image recording apparatus 1. In the suction space 22-1 of the suction frame 22-2, two adsorption force adjusting units 80 and 90 are provided. Each of the adsorption force adjusting units 80 and 90 adjusts adsorption force for the recording medium 8 on the conveyance belt 26, which occurs by sucking air, according to the sizes S1, S2, and S3 of the recording medium 8.

Specifically, the respective adsorption force adjusting units 80 and 90 include a first partition member 81 and a second partition member 91, respectively. The first and second partition members 81 and 91 are parallel to each other in the conveyance direction A in the suction space 22-1, and disposed to face each other. The first and second partition members 81 and 91 are provided in a movable manner in the vertical directions (the arrow directions H1 and H2) with respect to the conveyance direction A in the respective suction spaces 22-1.

The respective adsorption force adjusting unit 80 and 90 are provided with a first partition member moving unit 82 and a second partition member moving unit 92, respectively. The first and second partition member moving unit 82 and 92 move the first and second partition members 81 and 91 in the arrow directions H1 and H2 according to the sizes S1, S2, and S3 of the recording member 8, respectively. The first and second partition members 81 and 91 move in the arrow directions H1 and H2 so as to vary the suction spaces 22-1 partitioned by the first and second partition members 81 and 91 according to the sizes S1, S2, and S3 of the recording medium 8.

In the first partition member moving unit 82, a first partition drive motor 83 is provided as a drive source. A first delivery mechanism 84 is connected to the rotation shaft of the first partition drive motor 83. The first delivery mechanism 84 converts the rotation of the rotation shaft of the first partition drive motor 83 into the movement of the first partition member 81 in the arrow direction H1 so as to be transmitted to the first partition member 81.

Specifically, in the rotation shaft of the first partition drive motor 83, a first worm gear 85 is provided. The first worm gear 85 is meshed with a first gear 86. The first gear 86 is provided at a first shaft 87. The first shaft 87 is disposed in parallel to the conveyance direction A, and movably provided in the arrow direction J1 parallel to the conveyance direction A. Therefore, the rotation of the first partition drive motor 83 is converted into the linear movement of the first shaft 87 in the arrow direction J1 via the first worm gear 85 and the first gear 86.

A first delivery conversion mechanism 88 and a second delivery conversion mechanism 89 are provided on both ends of the first shaft 87, respectively. The first and second delivery conversion mechanisms 88 and 89 convert the linear movement of the first shaft 87 in the arrow direction J1 into the movement of the first partition member 81 in the arrow direction H1.

The first delivery conversion mechanism 88 includes a first delivery member 88-1 and a second delivery member 88-2. One end of the first delivery member 88-1 is provided to move freely with respect to first shaft 87, and the other end thereof is provided to move freely with respect to the first partition member 81. One end of the second delivery member 88-2 is provided at the conveyance housing 22, and the other end thereof is provided to move freely with respect to the center portion of the first delivery member 88-1.

The second delivery conversion mechanism 89 includes a first delivery member 89-1 and a second delivery member 89-2. One end of the first delivery member 89-1 is provided to move freely with respect to first shaft 87, and the other end thereof is provided to move freely with respect to the first partition member 81. One end of the second delivery member 89-2 is provided at the conveyance housing 22, and the other end thereof is provided to move freely with respect to the center portion of the first delivery member 89-1.

The second partition member moving unit 92 is configured equal to the first partition member moving unit 82. The second partition member moving unit 92 includes a first partition drive motor 93 and a first delivery mechanism 94. The first delivery mechanism 94 includes a first worm gear 95, a first gear 96, a first shaft 97, a first delivery conversion mechanism 98, and a second delivery conversion mechanism 99. The first delivery conversion mechanism 98 includes a first delivery member 98-1 and a second delivery member 98-2. The second delivery conversion mechanism 99 includes a first delivery member 99-1 and a second delivery member 99-2.

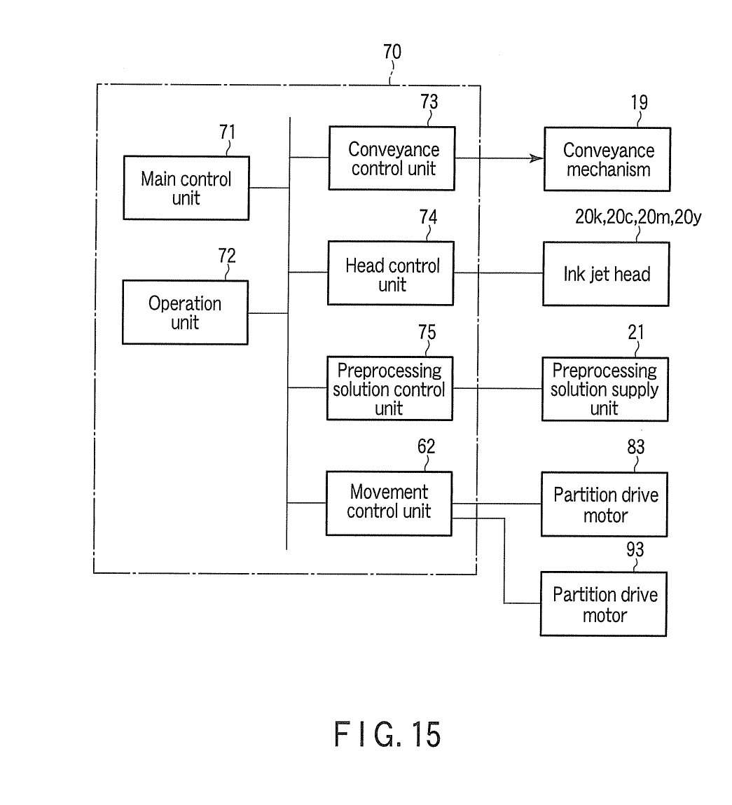

FIG. 15 is a diagram illustrating the configuration of a recording control unit 70. The movement control unit 62 receives the sizes S1, S2, and S3 of the recording medium 8 which are set by the operation unit 72, and controls the operations of the respective partition drive motors 83 and 93 of the first and second partition member moving units 82 and 92. Further, the movement control unit 62 respectively interlocks and moves the first and second partition members 81 and 91 in the arrow directions H1 and H2 so as to be disposed on respective positions according to both edges of the respective sizes S1, S2, and S3 of the recording medium 8.

Next, the operation of the apparatus as configured above will be described.

When the size of the recording medium 8 is set to the size Si in the operation unit 72, the movement control unit 62 controls the operations of the first and second partition drive motors 83 and 93. The rotation of the first partition drive motor 83 is converted into the linear movement of the first shaft 87 in the arrow direction J1 via the first worm gear 85 and the first gear 86. The first and second delivery conversion mechanisms 88 and 89 are interlocked with each other and convert the linear movement of the first shaft 87 in the arrow direction J1 into the movement of the first partition member 81 in the arrow direction H1.

Further, the rotation of the second partition member drive motor 93 is converted into a linear movement of the first shaft 97 in the arrow direction J2 via the first worm gear 95 and the first gear 96. The first and second delivery conversion mechanisms 98 and 99 are interlocked with each other and convert the linear movement of the first shaft 97 in the arrow direction J2 into the movement of the first partition member 91 in the arrow direction H1.

As a result, the first and second partition members 81 and 91 are respectively interlocked and moved in the arrow directions H1 and H2 so as to be disposed on the respective positions corresponding to both ends of the size Si of the recording medium 8.

As the rotation of the respective adsorbing fans 27a, 27b, and 27c, air is sucked through the respective suction ports 26a of the conveyance belt 26, the respective first suction ports 32 of the top plate 30, the suction space 22-1 partitioned by the first and second partition members 81 and 91 according to the size Si of the recording medium 8, and the respective duct openings 22-4 to 22-6. As the air is sucked in, the size Si of the recording medium 8 is adsorbed onto the conveyance belt 26.

When the size of the recording medium 8 is set to the size S2, the first and second partition members 81 and 91 are disposed on the respective positions corresponding to both ends of the size S2 of the recording medium 8 as described above.

When the size of the recording medium 8 is set to the size S3, the first and second partition members 81 and 91 are disposed on the respective positions corresponding to both ends of the size S3 of the recording medium 8.

According to the second embodiment as described above, the first and second partition members 81 and 91 are disposed according to the respective sizes S1, S2, and S3 of the recording medium 8, and the size of the suction space 22-1 partitioned by the first and second partition members 81 and 91 is varied according to the respective sizes S1, S2, and S3 of the recording medium 8. As a result, as the respective sizes S1, S2, and S3 of the recording medium 8 become smaller, the adsorption range of the recording medium 8 on the conveyance belt 26 becomes smaller. Therefore, the recording medium 8 can be adsorbed onto the conveyance belt 26 with the adsorption force according to the sizes S1, S2, and S3 of the recording medium 8. Similarly to the first embodiment, a high recording quality can be achieved on the recording medium 8.

The first and second partition member moving units 82 and 92 may be configured as one partition member moving unit. The configuration has been described that the first and second partition drive motors 83 and 93 are provided, but it may be configured to move the first and second partition members 81 and 91 by one partition drive motor.

Next, the third embodiment of the invention will be described.

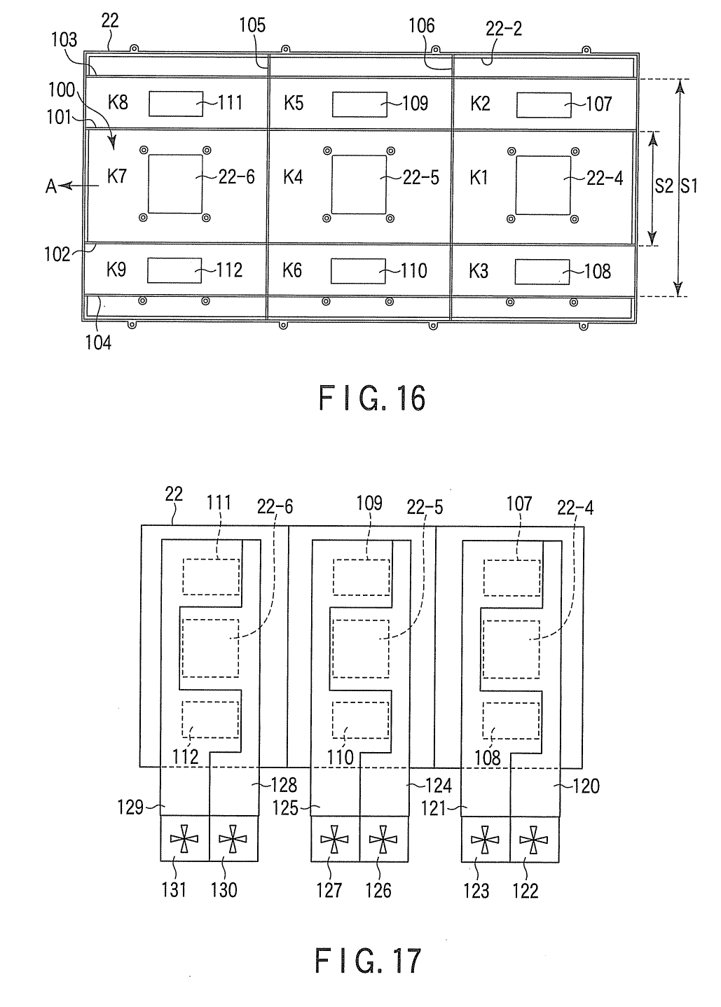

FIG. 16 is a diagram illustrating the configuration of the conveyance housing 22 of the image recording apparatus 1. In the suction space 22-1 of the suction frame 22-2, an adsorption force adjusting unit 100 is provided. The adsorption force adjusting unit 100 adjusts the adsorption force for the recording medium 8 on the conveyance belt 26, which occurs by sucking air, according to the sizes S1 and S2 of the recording medium 8. It is a matter of course that the adsorption force adjusting unit 100 can adjust the adsorption force for the recording medium 8 according to the sizes S1, S2, and S3 of the recording medium 8.

Specifically, the adsorption force adjusting unit 100 includes a plurality of division members 101 to 106. The respective division members 101 to 104 divide the suction space 22-1 in the vertical direction with respect to the conveyance direction A. The respective division members 105 and 106 divide the suction space 22-1 in the conveyance direction A. The respective division members 101 to 104 form a plurality of sucking sections K1 to K9. The respective division members 103 and 104 correspond to the edge positions of the size S1 of the recording medium 8. The respective division members 101 and 102 correspond to the edge positions of the recording medium 8 with the size S2.

In the sucking section K1, the respective sucking sections K2 and K3 are adjacent to each other in the vertical direction with respect to the conveyance direction A. In the sucking section K1, the duct opening 22-4 is provided. In the respective sucking sections K2 and K3, the respective duct openings 107 and 108 are provided, respectively. The opening area of the duct opening 22-4 is equal to the area overlapping with each of the opening areas of the respective duct openings 107 and 108.

In the sucking section K4, the respective sucking sections K5 and K6 are adjacent to each other in the vertical direction with respect of the conveyance direction A. In the sucking section K4, the duct opening 22-5 is provided. In the respective sections K5 and K6, the duct openings 109 and 110 are provided, respectively. The area of the duct opening 22-5 is equal to the area overlapping with each of the opening areas of the respective duct openings 109 and 110.

In the sucking section K7, the respective sucking sections K8 and K9 are adjacent to each other in the vertical direction with respect to the conveyance direction A. In the sucking section K7, the duct opening 22-6 is provided. In the respective sucking sections K8 and K9, the duct openings 111 and 112 are provided, respectively. The area of the duct opening 22-6 is equal to the area overlapping with each of the opening areas of the respective duct openings 111 and 112.

FIG. 17 is a diagram illustrating the layout of the ducts. The duct opening 22-4 is connected to a duct 120. The respective duct openings 107 and 108 are connected to the duct 121. In the duct 120, an adsorbing duct 122 is provided. In the duct 121, an adsorbing duct 123 is provided.

The duct opening 22-5 is connected to a duct 124. The respective duct openings 109 and 110 are connected to a duct 125. In the duct 124, an adsorbing fan 126 is provided. In the duct 125, an adsorbing fan 127 is provided.

The duct opening 22-6 is connected to a duct 128. The respective duct openings 111 and 112 are connected to a duct 129. In the duct 128, an adsorbing fan 130 is provided. In the duct 129, an adsorbing fan 131 is provided.

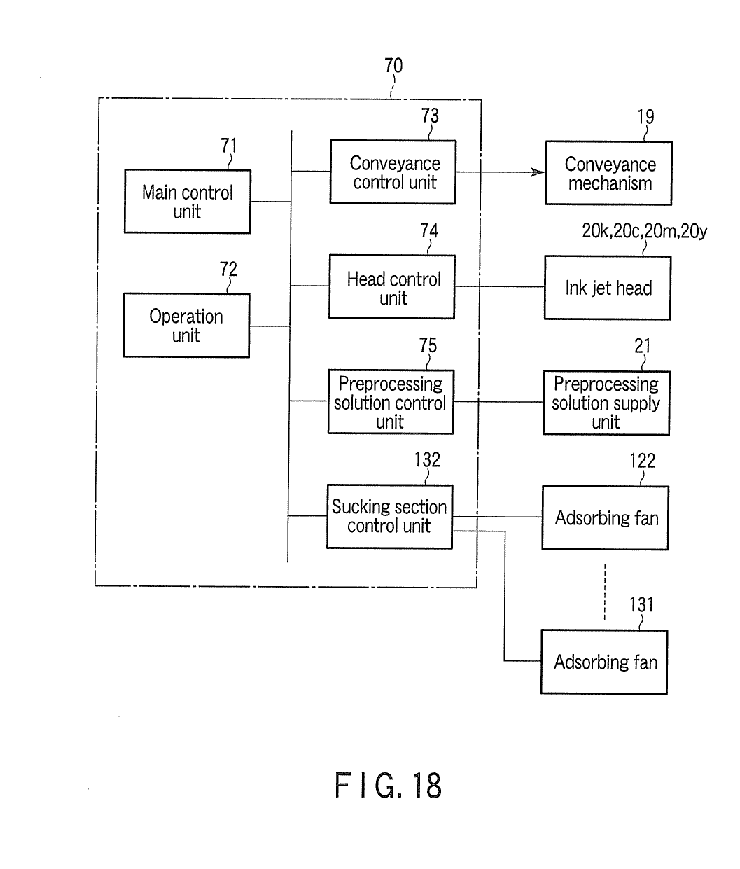

FIG. 18 is a diagram illustrating the configuration of the recording control unit 70. A sucking section control unit 132 receives the sizes S1 and S2 of the recording medium 8 which are set by the operation unit 72, selectively drives the respective adsorbing fans 122, 123, . . . , and 131 according to the sizes S1 and S2 of the recording medium 8, and rotatably controls the respective sucking sections K1 to K9 sucking air according to the sizes S1 and S2 of the recording medium 8.

When the size of the recording medium 8 is the size S1, all the adsorbing fans 122, 123, . . . , 131 of all the sucking sections K1, K2, . . . , K9.

When the size of the recording medium 8 is the size S2, the sucking section control unit 132 drives the adsorbing fans 122, 126, and 130 of the respective sucking sections K1, K4, and K7.

Next, the operation of the apparatus as configured above will be described.

When the size of the recording medium 8 is set to the size Si in the operation unit 72, the sucking section control unit 132 drives all the adsorbing fans 122, 123, . . . , and 131 of all the sucking sections K1, K2, . . . , and K9. As all the adsorbing fans 122, 123, . . . , and 131 are driven, air is sucked through all the ducts 120, 121, . . . , and 129 and through all duct openings 22-4, 22-5, . . . , 107, . . . , and 112. As a result, the suction is carried out at all the sucking sections K1 to K9 according to the size S2 of the recording medium 8.

The respective duct openings 22-4 to 22-6 are formed to have the same opening area. The area of the duct opening 22-4 is equal to the area overlapping with each of the respective areas of the respective duct openings 107 and 108. The area of the duct opening 22-5 is equal to each of the respective opening areas of the respective duct openings 109 and 110. The area of the duct opening 22-6 is equal to each of the respective area of the respective duct openings 111 and 112. Therefore, the recording medium 8 is adsorbed onto the conveyance belt 26 with uniform adsorption force over all the sucking sections K1 to K9.

When the size of the recording medium 8 is set to the size S2 in the operation unit 72, the sucking section control unit 132 drives the respective adsorbing fans 122, 126, and 130 of the respective sucking sections K1, K4, and K7. As the respective adsorbing fans 122, 126 and 130 are driven, air is sucked through the respective ducts 120, 124, and 128 and through the respective duct openings 22-4, 22-5, and 22-6. As a result, the suction is carried out at the respective sucking sections K1, K4, and K7 according to the size S1 of the recording medium 8.

According to the third embodiment as described above, the respective ducts 120, 121, . . . , and 129 are laid for each of the sucking sections K1 to K9, and the respective adsorbing fans 122, 123, . . . , and 131 provided at each of the ducts 120, 121, . . . , and 129 are selectively driven. Therefore, similarly to the first embodiment described above, the recording medium 8 can be adsorbed onto the conveyance belt 26 with adsorption force according to the sizes S1 and S2 of the recording medium 8, and a high recording quality can be achieved on the recording medium 8.

The respective adsorbing fans may be provided for each of the duct openings 22-4, 22-5, . . . , 107, . . . , and 112. In this case, the sucking section control unit 132 selectively drives the respective adsorbing fans according to the sizes S1 and S2 of the recording medium 8.

Next, the fourth embodiment of the invention will be described with reference to the drawings.

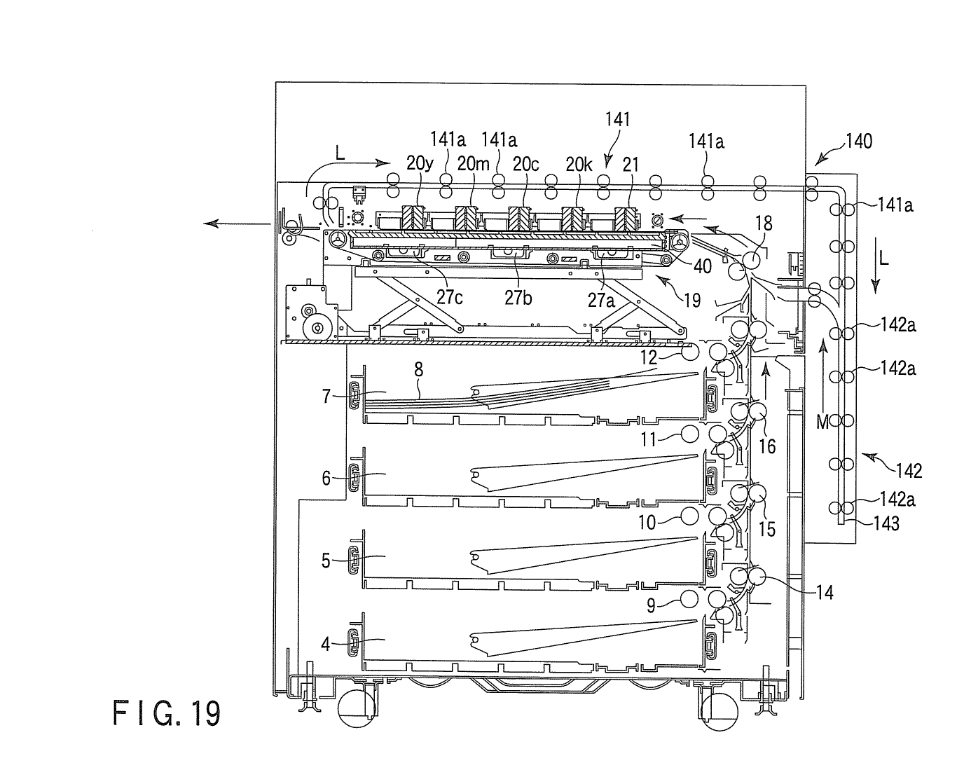

FIG. 19 is a diagram illustrating the configuration of the image recording apparatus 1. The image recording apparatus 1 carries out the recording on both surfaces of the recording medium 8. In the image forming unit 4, an inversion mechanism 140 is provided. The inversion mechanism 140 turns inversely one side (surface) of the recording medium 8, which is delivered from the conveyance mechanism 19, to the other side (rear surface). The inversion mechanism 140 includes a backward conveyance path 141 and a switchback conveyance path 142.

The backward conveyance path 141 conveys the recording medium 8 delivered from the conveyance mechanism 19 to the supplying side of the conveyance mechanism 19 (the arrow direction L). The backward conveyance path 141 includes a plurality of pairs of inversion rollers 141a. Each pair of inversion rollers 141a rotates in a direction so as to deliver the recording medium 8 in the arrow direction L.

The switchback conveyance path 142 backwardly switches the recording medium 8 returned to the backward conveyance path 141 (from the arrow direction M to the arrow direction N), and supplies the recording medium 8 to the conveyance mechanism 19 once again. The switchback conveyance path 142 includes a plurality of pairs of switchback rollers 141a which are disposed at predetermined intervals. Each pair of the switchback rollers 141a rotates in a direction so as to deliver the recording medium 8 in the arrow direction L. The recording medium 8 is inverted at timing when reaching the end 143 of the switchback conveyance path 142. Then, the recording medium 8 is delivered in the arrow direction M.

Under the top plate 30, any one of the adsorption force adjusting unit 40 as described in the first embodiment, the respective adsorption force adjusting units 80 and 90 as described in the second embodiment, and the adsorption force adjusting unit 100 as described in the third embodiment is provided.

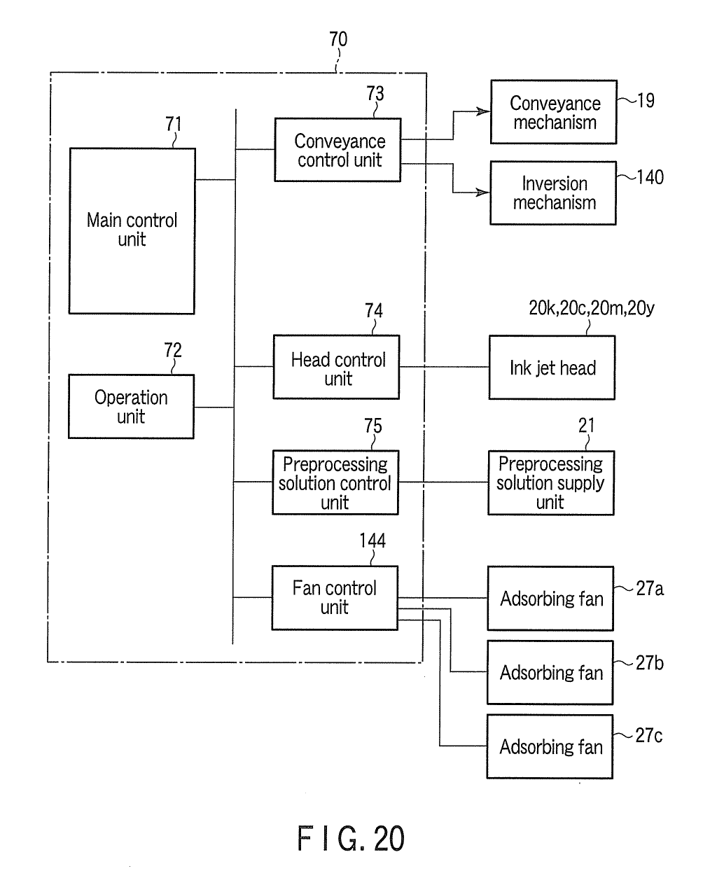

FIG. 20 is a diagram illustrating the configuration of the recording control unit 70. The conveyance control unit 73 controls the operation of the conveyance mechanism 19 as described above, rotatably drives the respective pairs of the inversion rollers 141a on the backward conveyance path 141 of the inversion mechanism 140, and rotatably drives the pair of the switchback rollers 141a on the switchback conveyance path 142. The conveyance control unit 73 inversely turns the rotation of the pair of the switchback rollers 141a at timing when the recording medium 8 reaches the end 143 of the switchback conveyance path 142.

At a point of when the recording medium 8 inverted by the inversion mechanism 140 is delivered to the conveyance mechanism 19 once again, a fan control unit 144 increases the rotating speed of the respective adsorbing fans 27a, 27b, and 27c. When the recoding medium 8 is recorded on its surface, the fan control unit 144 rotates the respective adsorbing fans 27a, 27b, and 27c at a first rotating speed. When the recording medium 8 is recorded on its rear surface, the fan control unit 144 rotates the respective adsorbing fans 27a, 27b, and 27c at a second rotating speed faster than the first rotating speed. The first and second rotating speeds are set in advance. When the inverted recording medium 8 is completely conveyed by the conveyance mechanism 19, the fan control unit 144 returns the rotating speed of the respective adsorbing fans 27a, 27b, and 27c from the second rotating speed to the first rotating speed.

Next, the operation of the apparatus as configured above will be described.

The conveyance mechanism 19 conveys the recording medium 8. The fan control unit 144 rotates the respective adsorbing fans 27a, 27b, and 27c at the first rotating speed. Therefore, the recording medium 8 is adsorbed onto the conveyance belt 26. Each of the ink jet heads 20k, 20c, 20m, and 20y ejects ink. Therefore, an image is recorded on the surface of the recording medium 8.

Thereafter, the backward conveyance path 141 of the inversion mechanism 140 conveys the recording medium 8 delivered from the conveyance mechanism 19 to the supplying side of the conveyance mechanism 19 (the arrow direction L). The switchback conveyance path 142 backwardly switches the recording medium 8 returned by the backward conveyance path 141 (from the arrow direction M to the arrow direction N), and supplies the recording medium 8 to the conveyance mechanism 19 once again. Therefore, the conveyance mechanism 19 is supplied with the recording medium 8 of which the rear surface is inverted.

The conveyance mechanism 19 conveys the inverted recording medium 8. The fan control unit 144 rotates the respective adsorbing fans 27a, 27b, and 27c at the second rotating speed faster than the first rotating speed. Therefore, the recording medium 8 is adsorbed onto the conveyance belt 26 with a greater adsorption force compared with the case where the surface is recorded. Each of the ink jet heads 20k, 20c, 20m, and 20y ejects ink. Therefore, an image is recorded on the surface of the recording medium 8.

According to the fourth embodiment as described above, when the surface of the recording medium 8 is recorded, the rotating speeds of the respective adsorbing fans 27a, 27b, and 27c are increased, so that the recording medium 8 is adsorbed onto the conveyance belt 26 with a greater adsorption force compared with the case where the surface of the recording medium 8 is recoded. In this case, even when any one of the adsorption force adjusting units 40, 80, 90, and 100 is provided under the top plate 30, the adsorption force is increased on the recording medium 8.

When ink is landed on the surface of the recording medium 8, the recording medium 8 absorbs the ink and is swollen in a wave shape so as to generate cockling in some cases. Since the recording medium 8 is adsorbed onto the conveyance belt 26 by a great adsorption force when the surface of the recording medium 8 is recorded, the recording medium 8 swollen in a wave shape can be corrected in a planar shape. Therefore, a high recording quality can be achieved on the recording medium 8.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image recording apparatus comprising:
a conveyance unit which includes a conveyance belt and an air suction unit for sucking air through the conveyance belt to adsorb a recording medium on the conveyance belt;
a recording head which ejects ink to carry out recording on the recording medium conveyed by the conveyance unit; and
an adsorption force adjusting unit which adjusts adsorption force for the recording medium on the conveyance belt, which occurs by sucking air, according to the size of the recording medium.

2. The apparatus according to claim 1,
wherein the adsorption force adjusting unit increases the adsorption force for the recording medium on the conveyance belt as a size of the recording medium becomes smaller.

3. The apparatus according to claim 2,
wherein the adsorption force adjusting unit sucks air within an area corresponding to the size of the recording medium.

4. The apparatus according to claim 3, further comprising:
a belt support member which supports the conveyance belt and is provided with a plurality of first suction ports through which air is passed,
wherein the adsorption force adjusting unit includes a suction port varying member which is provided between the belt support member and the air suction unit and is provided with a plurality of second suction ports through which the air is passed, and
a member moving unit which moves the suction port varying member with respect to the belt support member and varies the first suction port which opens according to the size of the recording medium.

5. The apparatus according to claim 4,
wherein the respective second suction ports include suction ports which are formed in rectangular shapes greater than the respective first suction ports, and
wherein the suction port in the rectangular shape is provided such that a longitudinal direction of the rectangular shape is set to the moving direction of the suction port varying member and the length thereof in the longitudinal direction is different according to the respective sizes of the recording mediums.

6. The apparatus according to claim 5,
wherein the suction port varying member is provided with the respective second suction ports which are different in length in the longitudinal direction for the respective areas corresponding to the respective sizes of the recording mediums, and
wherein the member moving unit moves the suction port varying member and varies the respective first suction ports, which are opened by overlapping the respective second suction ports with the respective first suction ports, according to the respective sizes.

7. The apparatus according to claim 4,
wherein the belt support member is formed in a planar shape, and
wherein the suction port varying member is formed in a planar shape and disposed in plane-parallel to a plane surface of the belt support member.

8. The apparatus according to claim 4, further comprising:
a movement control unit,
wherein the member moving unit includes a drive source which generates driving force and a delivery mechanism which converts the driving force of the drive source into movement of the suction port varying member, and
wherein the movement control unit controls the drive source and a travel amount of the suction port varying member according to the respective sizes of the recording mediums.

9. The apparatus according to claim 3,
wherein the adsorption force adjusting unit includes a suction frame which is provided between the conveyance belt and the air suction unit and forms a suction space through which the air sucked via the conveyance belt flows,
two partition members which-vary the size of the suction space, and
a partition member moving unit which moves the respective partition members within the suction frame according to the size of the recording medium.

10. The apparatus according to claim 9,
wherein the respective partition members move to a vertical direction with respect to a conveying direction of the recording medium.

11. The apparatus according to claim 9, further comprising:
a movement control unit,
wherein the partition member moving unit includes a drive source which generates driving force and a delivery mechanism which converts the driving force of the drive source into movement of the respective partition members, and
wherein the movement control unit controls the drive source and a travel amount of the respective partition members according to the size of the recording medium.

12. The apparatus according to claim 9, further comprising:
a movement control unit,
wherein the respective partition members are arranged in parallel with each other in the suction frame in the vertical direction with respect to the conveying direction of the recording medium,
wherein the partition member moving unit includes a first partition member moving unit which moves one partition member and a second partition member moving unit which moves the other partition member, and
wherein the movement control unit controls operations of the first and second partition member moving units, and interlocks the one partition member with the other partition member to be moved in the vertical direction with respect to the conveying direction of the recording medium.

13. The apparatus according to claim 3, further comprising:
a sucking section control unit,
wherein the adsorption force adjusting unit includes a suction frame which is provided between the conveyance belt and the air suction unit and forms a suction space through which the air sucked via the conveyance belt flows, and a division member which divides the suction frame into plural pieces to form a plurality of sucking sections, and
wherein the sucking section control unit controls the respective sucking sections through which the air is sucked according to the size of the recording medium.

14. The apparatus according to claim 13,
wherein the air suction unit includes a plurality of fans which are provided corresponding to the respective sucking sections, and
wherein the sucking section control unit selectively drives the respective fans according to the size of the recording medium.

15. The apparatus according to claim 13, further comprising:
a plurality of duct openings which are provided for each of the sucking sections;
a plurality of ducts which are connected to the respective duct openings for each sucking section according to the size of the recording medium; and
a plurality of fans which are provided for each of the ducts,
wherein the sucking section control unit selectively drives the respective fans according to the size of the recording medium.

16. The apparatus according to claim 1,
wherein the conveyance unit includes an inversion mechanism which inverts the recording medium,
wherein if one surface of the recording medium is recorded and then the recording medium is inverted by the inversion mechanism so as to record the other surface of the recording medium, the adsorption force adjusting unit increases adsorption force for the recording medium in case that a second surface of the recording medium is recorded compared with adsorption force for the recording medium if a first surface of the recording medium is recorded.

17. The apparatus according to claim 16,
wherein the air suction unit includes a fan for sucking air, and
wherein the adsorption force adjusting unit increases a rotating speed of the fan if the second surface of the recording medium is recorded.

18. An image recording apparatus according comprising:
conveyance means, which includes a conveyance belt, a movement mechanism which moves the conveyance belt, and an air suction unit which sucks air through the conveyance belt and adsorbs the recording medium onto the conveyance belt, for adsorbing the recording medium onto the conveyance belt to be conveyed;
recording means for ejecting ink on the recording medium which is conveyed by the conveyance means so as to carry out recording thereon; and
adsorption force adjusting means for adjusting adsorption force for the recording medium on the conveyance belt, which occurs by sucking the air, according to a size of the recording medium.

19. The apparatus according to claim 18,
wherein the adsorption force adjusting means increases the adsorption force for the recording medium on the conveyance belt as the size of the recording medium becomes smaller.
